(19) United States
(12) Patent Application Publication
(10) Pub. No.: US 2015/0255968 A1
(43) Pub. Date: Sep. 10, 2015

(54) Conductor Management Assembly

(71) Applicant: Jason Mc Keeman, Greenfield, IN (US)

(72) Inventor: Jason Mc Keeman, Greenfield, IN (US)

(21) Appl. No.: 14/199,273

(22) Filed: Mar. 6, 2014

(51) Int. Cl. H02G 3/04

(52) U.S. Cl. CPC H02G 3/045

(57) ABSTRACT

A conductor management assembly for supporting and arranging the conductors includes a cable extending along a support surface. A tube is operationally coupled to the support surface. The tube has a pair of cable apertures extending therethrough. The pair of cable apertures each is positioned on opposite sides of the tube so the cable extends through the pair of cable apertures. The tube has a support hole extending therethrough. A fastener is extendable through the support hole to engage the support surface. The tube has a pair of coupler openings extending therethrough. A coupler is extendable through the pair of coupler openings. The coupler engages an additional one of the cables so the additional cable is retained on the tube.

### BACKGROUND OF THE DISCLOSURE

1. Field of the Disclosure

The disclosure relates to conductor management devices and more particularly pertains to a new conductor management device for supporting and arranging the conductors.

2. SUMMARY OF THE DISCLOSURE

An embodiment of the disclosure meets the needs presented above by generally comprising a cable extending along a support surface. A tube is operationally coupled to the support surface. The tube has a pair of cable apertures extending therethrough. The pair of cable apertures each is positioned on opposite sides of the tube so the cable extends through the pair of cable apertures. The tube has a support hole extending therethrough. A fastener is extendable through the support hole to engage the support surface. The tube has a pair of coupler openings extending therethrough. A coupler is extendable through the pair of coupler openings. The coupler engages an additional one of the cables so the additional cable is retained on the tube.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is an in-use view of a conductor management assembly according to an embodiment of the disclosure.

FIG. 2 is a front perspective view of an embodiment of the disclosure.

FIG. 3 is an exploded perspective view of an embodiment of the disclosure.

FIG. 4 is a top perspective view of an embodiment of the disclosure.

FIG. 5 is a cross sectional view taken along line 5-5 of FIG. 2 of an embodiment of the disclosure.

### DESCRIPTION OF THE PREFERRED EMBODIMENT

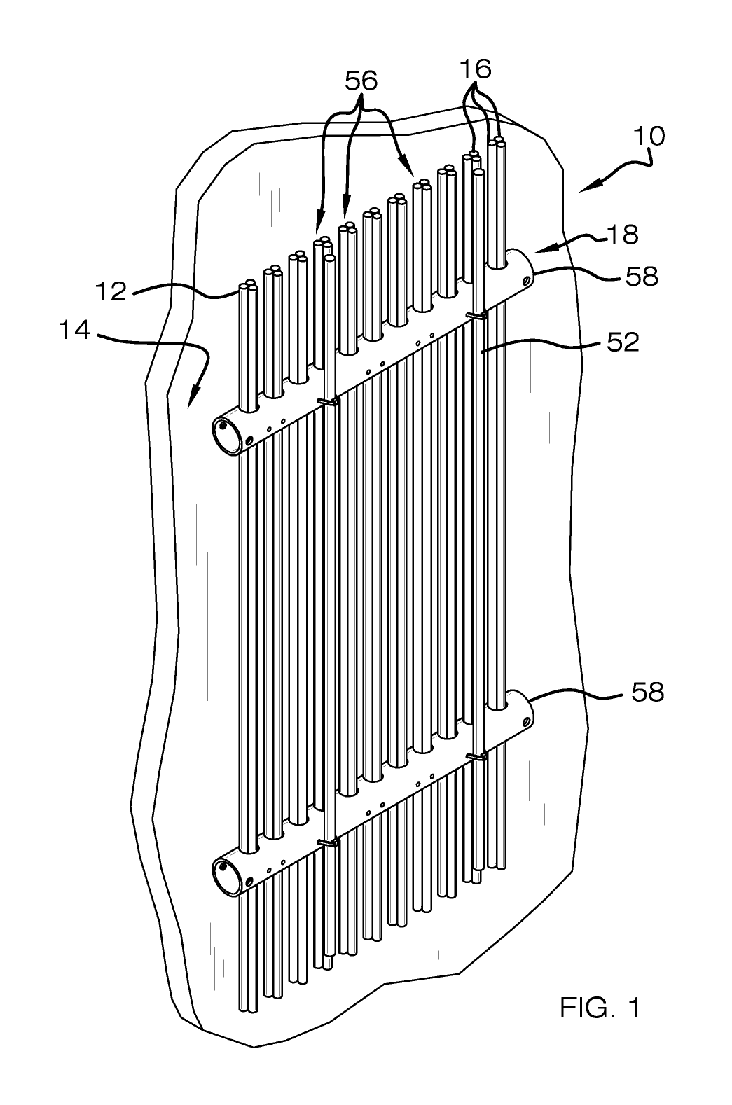

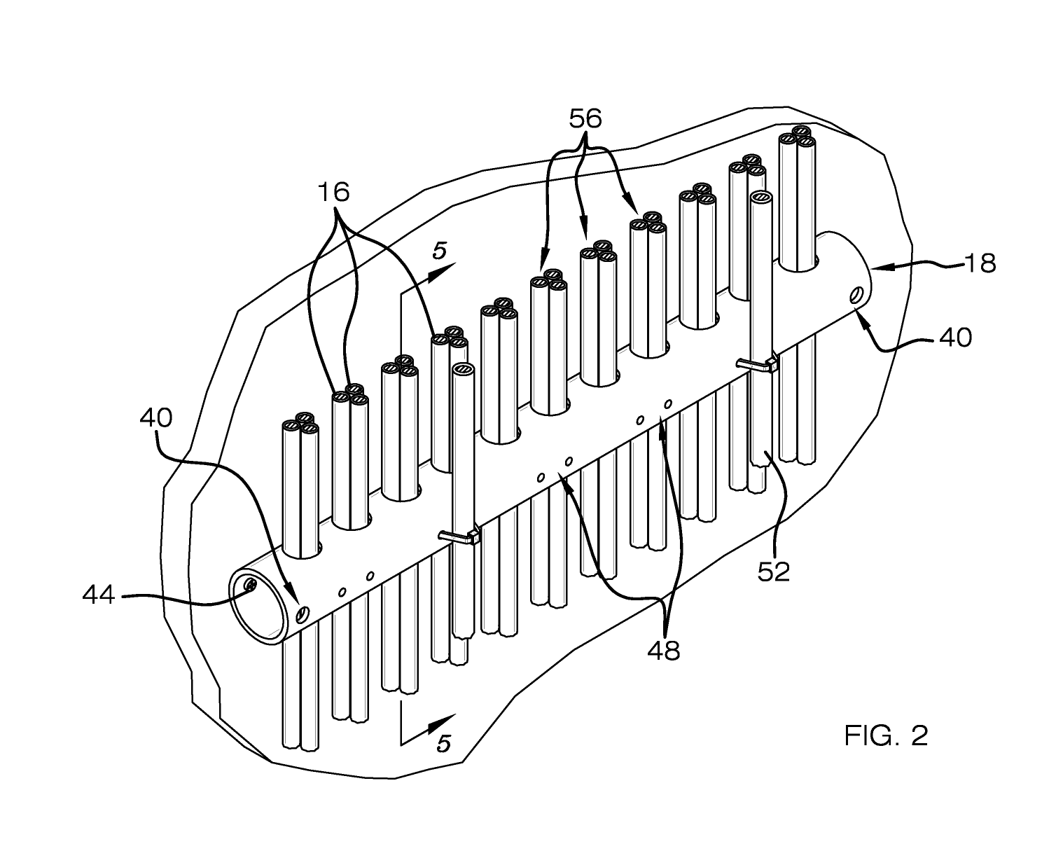

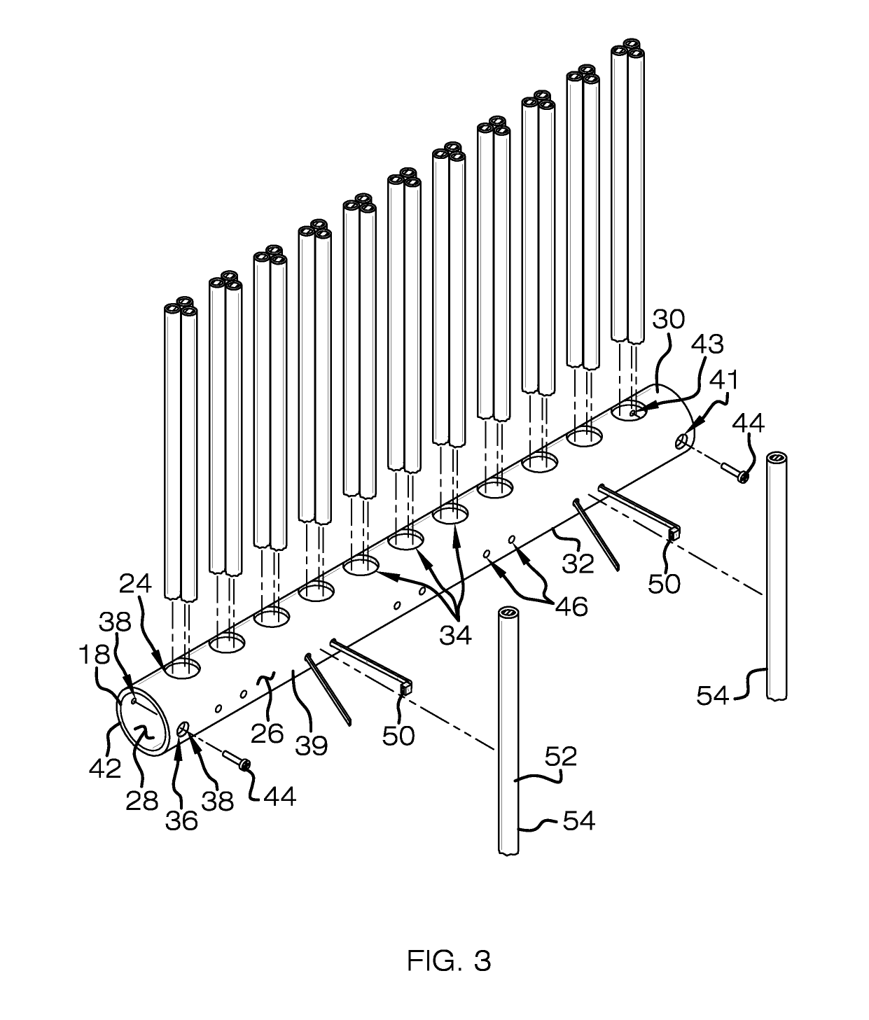

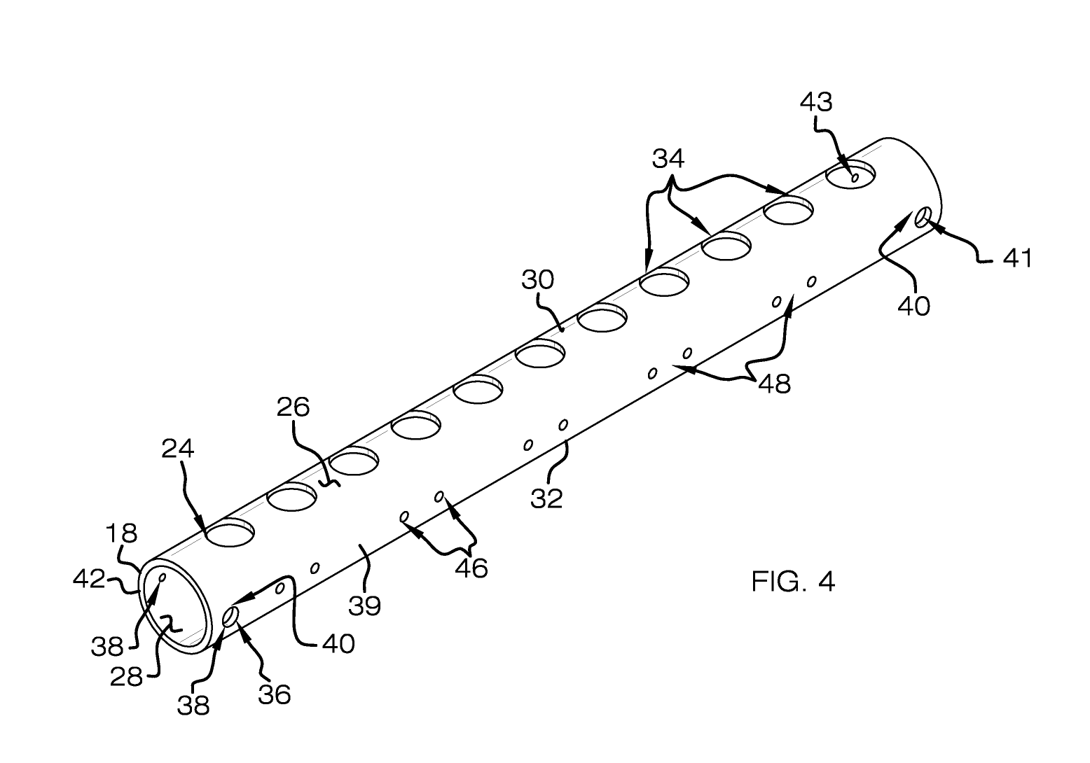

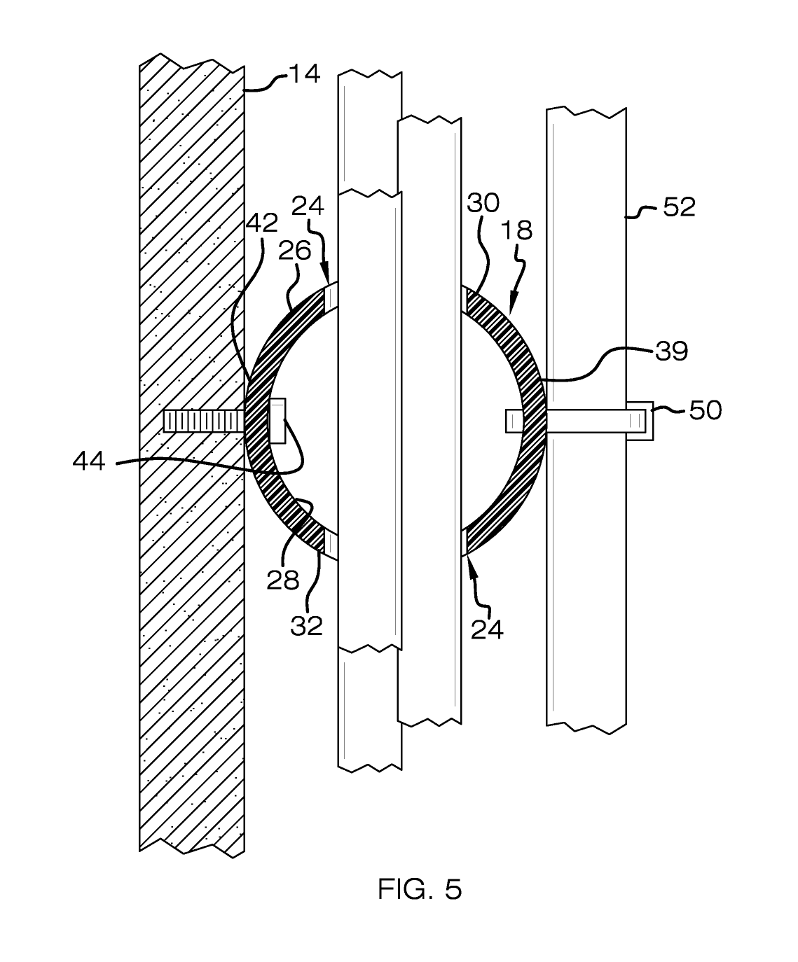

With reference now to the drawings, and in particular to FIGS. 1 through 5 thereof, a new conductor management device embodying the principles and concepts of an embodiment of the disclosure and generally designated by the reference numeral 10 will be described.

As best illustrated in FIGS. 1 through 5, the conductor management assembly 10 generally comprises a cable 12 extending along a support surface 14. The cable 12 may be an electrical cable of any conventional design. Additionally, the support surface 14 may be a wall or a ceiling of any conventional design. The cable 12 is one of a plurality of the cables 16 each positioned proximate one another.

A tube 18 has a first end 20 and a second end 22. The tube 18 is elongated between the first 20 and second 22 ends. The tube 18 may be comprised of a rigid and electrically insulating material such as PVC or other similar material. Finally, the tube 18 may have a diameter between 2 cm and 8 cm and a length between 30 cm and 120 cm.

The tube 18 has a pair of cable apertures 24 extending through an outer surface 26 and an inner surface 28 of the tube 18. The pair of cable apertures 24 is each positioned on an associated one of a top side 30 and a bottom side 32 of the tube 18 so the pair of cable apertures 24 are aligned with each other. Additionally, the pair of cable apertures 24 may each have a diameter between 12 mm and 25 mm. The pair of cable apertures 24 is one of a plurality of sets of the pair of cable apertures 34. Moreover, the plurality of sets of the pair of cable apertures 34 is evenly spaced apart and distributed between the first 20 and second 22 ends of the tube 18. The plurality of cables 16 is each extendable through an associated one of the plurality of sets of the pair of cable apertures 34 so the plurality of cables 16 are spaced apart and organized.

The tube 18 has a support hole 36 extending through the outer 26 and inner 28 surfaces of the tube 18. The support hole 36 is positioned on a front side 39 of the tube 18. The support hole 36 is one of a pair of the support holes 38 each positioned on an associated one of the front side 39 and a back side 42 of the tube 18. Moreover, the pair of support holes 38 is one of a pair of sets of the support holes 40 each positioned proximate an associated one of the first 20 and second 22 ends of the tube 18. A front one of the pair of support holes 41 has a diameter that is greater than a diameter of back one of the pair of support holes 43.

A pair of fasteners 44 is each extendable through an associated one of each of the pair of sets of the support holes 38. The pair of fasteners 44 each engages the support surface 14 so the tube 18 is retained on the support surface 14. The pair of fasteners 44 fits through the front support hole 41 and engages the inside surface 28 of the tube 18. Finally, the pair of fasteners 44 may be a screw of any conventional design.

The tube 18 has a pair of coupler openings 46 each extending through the outer 26 and inner 28 surfaces of the tube 18. The pair of coupler openings 46 is each positioned on the front side 39 of the tube 18. Additionally, the pair of coupler openings 46 may have a diameter between 2 mm and 4 mm. The pair of coupler openings 46 is spaced apart. Moreover, the pair of coupler openings 46 is one of a plurality of sets of the pair of coupler openings 48. The plurality of sets of the couplers openings 48 is evenly spaced apart and distributed between the first 20 and second 22 ends of the tube 18.

A plurality of couplers 50 each is extendable through an associated one of the plurality of sets of the pair of coupler openings 48. The plurality of couplers 50 engages an additional one of cables 52 so the additional cable 52 is retained on the tube 18. The plurality of couplers 50 may each comprise a Zip Tie of any conventional design. Additionally, the additional cable 52 may be one of a plurality of additional cables 54. The plurality of additional cables 54 are engaged by the associated one of the plurality of couplers 50 if all of the plurality of sets of the pair of cable apertures 34 are filled with the plurality of cables 16.

The assembly 10 is one of a plurality of assemblies 58. Each of the plurality of assemblies 58 is spaced apart on the support surface 14. Additionally, the plurality of assemblies 58 is aligned with each other on the support surface 14 in order to route the plurality of cables 16. The plurality of cables 16 extends through each of the plurality of assemblies 10 so the plurality of cables 16 is organized and supported on the support surface 14.

In use, the tube 18 is cut longitudinally to a desired length. The tube 18 is mounted to the support surface 14 using the pair of fasteners 44. Continuing, the plurality of cables 16 is extended through each of the plurality of sets of the pair of cable apertures 34. A single cable 16 or a group of the plurality of cables 56 may be extended through each of the plurality of sets of the pair of cable apertures 34. Each of the plurality of couplers 50 is extended through a selected one of the plurality of sets of the pair of coupler openings 48. The additional cable 52 is left permanently coupled to the tube 18 or the additional cable 52 is removed if the additional cable 52 is intended for temporary use. The assembly 10 is utilized during construction on residential, commercial or industrial construction projects.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A conductor management assembly for supporting and arranging the conductors, said assembly comprising:
a cable extending along a support surface;
a tube operationally coupled to the support surface;
said tube having a pair of cable apertures extending therethrough, said pair of cable apertures each being positioned on opposite sides of said tube such that said cable extends through said pair of cable apertures;
said tube having a support hole extending therethrough such that a fastener is extendable through said support hole to engage the support surface; and
said tube having a pair of coupler openings extending therethrough such that a coupler is extendable through said pair of coupler openings, said coupler engaging an additional one of said cables such that said additional cable is retained on said tube.

2. The assembly according to claim 1, wherein said cable being one of a plurality of said cables each positioned proximate one another.

3. The assembly according to claim 1, wherein said tube having a first end and a second end, said tube being elongated between said first and second ends.

4. The assembly according to claim 1, wherein said pair of cable apertures extending through an outer surface and an inner surface of said tube.

5. The assembly according to claim 1, wherein said pair of cable apertures each being positioned on an associated one of a top side and a bottom side of said tube such that said pair of cable apertures are aligned with each other.

6. The assembly according to claim 5, wherein said pair of cable apertures being one of plurality of sets of said cable apertures.

7. The assembly according to claim 6, wherein said plurality of sets of cable apertures being evenly spaced apart and distributed between a first end and a second end of said tube.

8. The assembly according to claim 1, wherein a plurality of said cables each being extendable through an associated one of a plurality of sets of said pair of cable apertures such that said plurality of cables are spaced apart and organized.

9. The assembly according to claim 1, wherein said support hole extending through an outer surface and an inner surface of said tube.

10. The assembly according to claim 1, wherein said support hole being one of a pair of said support holes such that said pair of support holes is each positioned on an associated one of a front side and a back side of said tube.

11. The assembly according to claim 10, wherein said pair of support holes being one of a pair of sets of said support holes each positioned proximate an associated one of a first end and a second end of said tube.

12. The assembly according to claim 1, said pair of coupler openings each extending through an outer surface and an inner surface of said tube, said pair of coupler openings each being positioned on a front side of said tube such that said pair of coupler openings is spaced apart.

13. The assembly according to claim 1, said pair of coupler openings being one of a plurality of sets of said pair of coupler openings, said plurality of sets of said pair of coupler openings being evenly spaced apart and distributed between a first end and a second end of said tube.

14. The assembly according to claim 1, wherein said coupler being one of a plurality of said couplers each being extendable through an associated one of a pair of sets of said pair of coupler openings.

15. A conductor management assembly for supporting and arranging the conductors, said assembly comprising:
a cable extending along a support surface, said cable being one of a plurality of said cables each positioned proximate one another;
a tube having a first end and a second end, said tube being elongated between said first and second ends, said tube being operationally coupled to the support surface;
said tube having a pair of cable apertures extending through an outer surface and an inner surface of said tube, said pair of cable apertures each being positioned on an associated one of a top side and a bottom side of said tube such that said pair of cable apertures are aligned with each other;
said pair of cable apertures being one of a plurality of sets of said pair of cable apertures, said plurality of sets of cable apertures being evenly spaced apart and distributed between said first and second ends of said tube, said plurality of cables each being extendable through an associated one of said plurality of sets of said pair of cable apertures such that said plurality of cables are spaced apart and organized;
said tube having a support hole extending through said outer and inner surfaces of said tube, said support hole being positioned on a front side of said tube;
said support hole being one of a pair of said support holes such that said pair of support holes is each positioned on an associated one of a front side and a back side of said tube;
said pair of support holes being one of a pair of sets of said support holes each positioned proximate an associated one of said first and second ends of said tube;
a pair of fasteners each being extendable through an associated one of each of said pair of sets of said support holes to engage the support surface such that said tube is retained on the support surface;
said tube having a pair of coupler openings each extending through said outer and inner surfaces of said tube, said pair of coupler openings each being positioned on said front side of said tube such that said pair of coupler openings is spaced apart, said pair of coupler openings being one of a plurality of sets of said pair of coupler openings, said plurality of sets of said pair of couplers openings being evenly spaced apart and distributed between said first and second ends of said tube; and
a plurality of couplers each being extendable through an associated one of said pair of sets of said pair of coupler openings, said plurality of couplers engaging an additional one of said cables such that said additional cable is retained on said tube.
